(19) United States
(12) Patent Application Publication
(10) Pub. No.: US 2017/0330468 A1
(43) Pub. Date: Nov. 16, 2017

(54) POLICE SCENE TRAINING APPARATUS

(71) Applicant: Wayne L. Davis, Orland, IN (US)

(72) Inventor: Wayne L. Davis, Orland, IN (US)

(21) Appl. No.: 15/155,423

(22) Filed: May 16, 2016

(51) Int. Cl. G09B 1/18; G09B 19/00

(52) U.S. Cl. CPC G09B 1/18; G09B 19/00

(57) ABSTRACT

A police scene training apparatus is provided. The police scene training apparatus includes a first sidewall, a second sidewall, and a plurality of dowels. Each of the dowels includes a first end secured to the first sidewall and a second end secured to the second sidewall. The plurality of dowels are oriented above and below one another. A plurality of blocks are rotatably disposed about each of the plurality of dowels. Each of the plurality of blocks include a plurality of sides, where at least two of the sides include an image. The sides of the blocks align with one another to form a surface having a plurality of images forming a police investigative scene depiction.

### BACKGROUND OF THE INVENTION

The present invention relates to criminal justice training and, more particularly, to a training kit for investigating police scenes.

Criminal Justice is the system of practices and institutions of governments directed at upholding social control, deterring and mitigating crime, or sanctioning those who violate laws with criminal penalties and rehabilitation efforts. Criminal justice degree programs at four-year institutions typically include coursework in statistics, methods of research, criminal justice, policing, U.S court systems, criminal courts, corrections, community corrections, criminal procedure, criminal law, victimology, juvenile justice, and a variety of special topics. A number of colleges and universities offer a Bachelor of Criminal Justice. Currently, colleges and universities are unable to properly teach criminal justice students how to investigate a police scene due to limited budgeting.

As can be seen, there is a need for an improved training aid for investigating police scenes.

### SUMMARY OF THE INVENTION

In one aspect of the present invention, a police scene training apparatus comprises: a first sidewall and a second sidewall; a plurality of dowels, each comprising a first end secured to the first sidewall and a second end secured to the second sidewall, wherein the plurality of dowels are oriented above and below one another; a plurality of blocks rotatably disposed about each of the plurality of dowels, wherein each of the plurality of blocks comprises a plurality of sides, wherein at least two of the plurality of sides of each of the plurality of blocks comprises an image, and a plurality of aligned sides form a surface comprising a plurality of images forming a police investigative scene depiction.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is a perspective view of an embodiment of the present invention illustrating exemplary images exploded from blocks;

FIG. 4 is an exploded view of an embodiment of the present invention;

FIG. 5 is a section view of an embodiment of the present invention taken from line 5-5 in FIG. 1;

FIG. 6 is an enlarged section view of an embodiment of the present invention;

FIG. 7 is a perspective view of an alternate embodiment of the present invention; and

FIG. 8 is a perspective view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a changeable crime/crash scene using triangular prisms with various images. The triangular prism design is a self-contained, small, portable, tool that allows for changeable crime and crash scenes at a low cost. This design can replace many tools currently used. Further, the present invention may be used for hands-on measurements and photographs.

Since the images are in specific locations on each side of each prism, reconstructing a crime scene or crash scene can be more exact. An instructor can easily assess a student's work later on by setting up each prism as seen by the student at the time of the assignment. Turning prisms are easier, quicker, and more exact than placing loose pieces on a board.

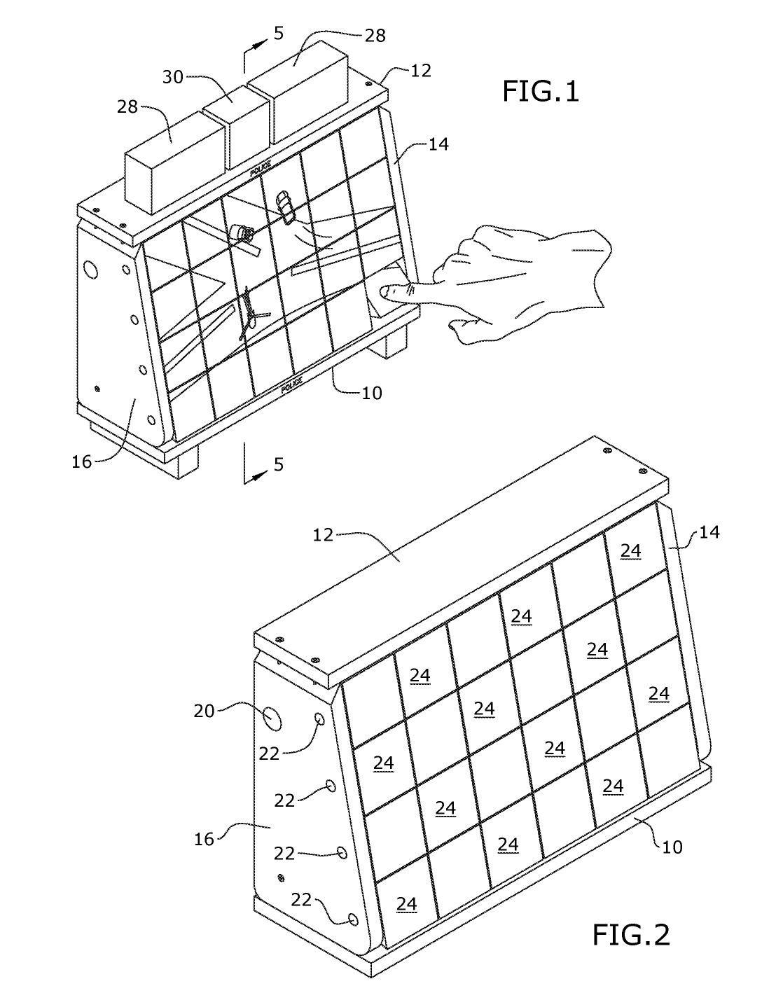

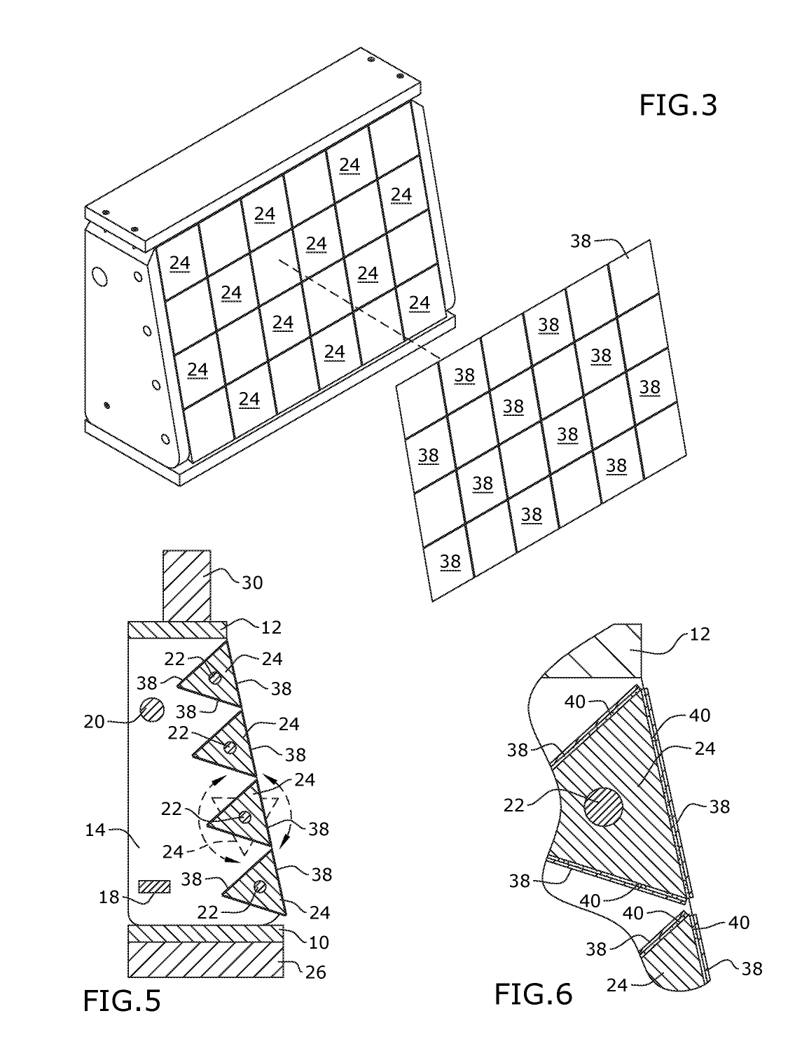

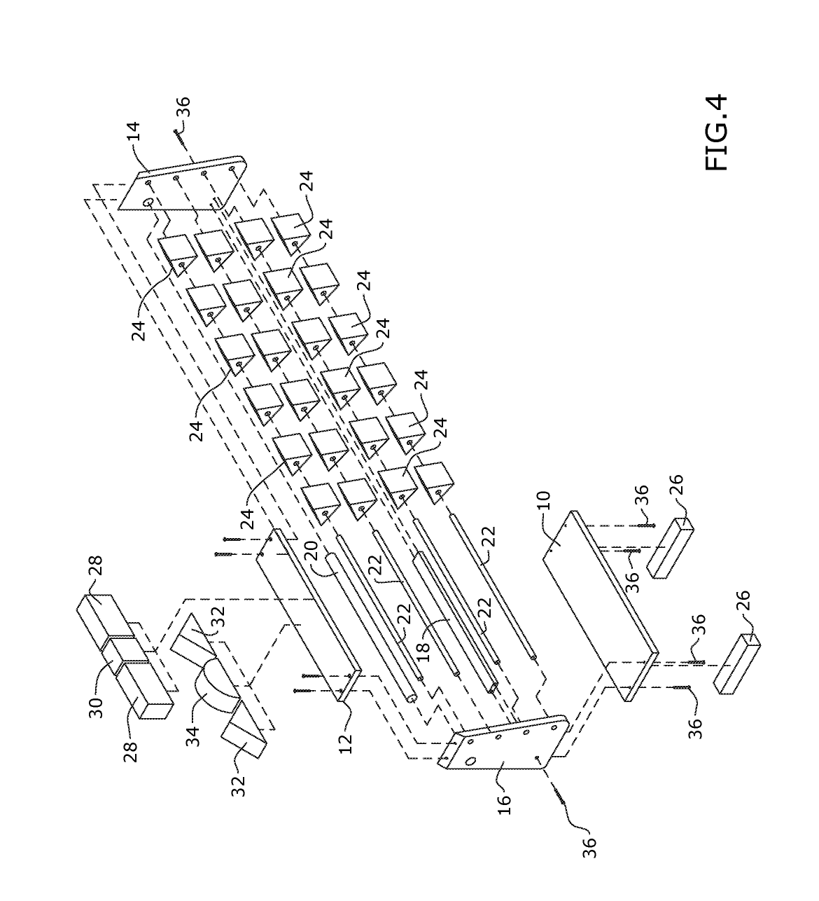

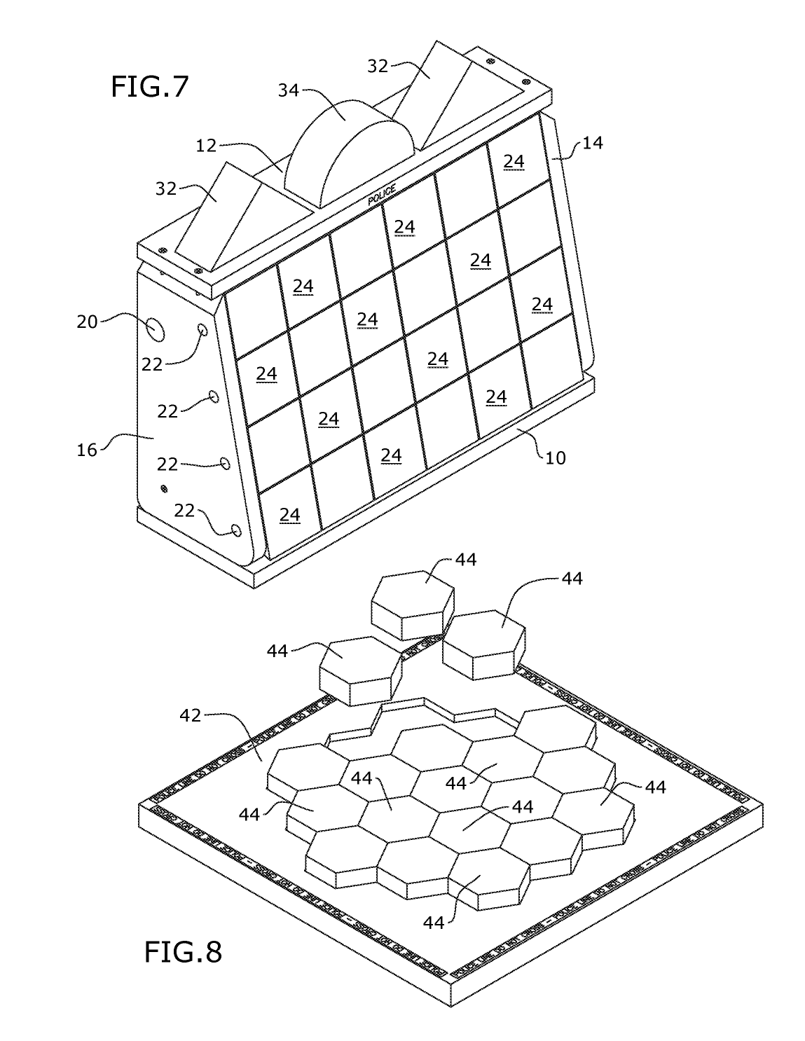

Referring to FIGS. 1 through 6, the present invention includes a police scene training apparatus. The police scene training apparatus includes a first sidewall 14, a second sidewall 16, and a plurality of dowels 22. Each of the dowels 22 include a first end secured to the first sidewall 14 and a second end secured to the second sidewall 16. The plurality of dowels 22 are oriented above and below one another and may align to form a slanted angle from the top end to the bottom end. A plurality of blocks 24 are rotatably disposed about each of the plurality of dowels 22. Each of the plurality of blocks 24 include a plurality of sides, where at least two of the sides include an image 38. The sides of the blocks align with one another to form a surface having a plurality of images 38 forming a police investigative scene depiction.

As mentioned above, the plurality of images 38 form a police investigative scene, such as a car crash or crime scene. The images 38 aligned together may form the same police investigative scene depiction on each side. However, each image 38 may include a different depicted item. For example, the depicted items may include a car, a truck, a weapon, a body, glass, blood, bullet casings, and the like. Therefore, users may rotate the blocks 24 and depict the same scene with different items.

In certain embodiments, the present invention may further include a base 10 connecting the first and second sidewalls 14, 16 at a bottom end, and a cover 12 connecting the first and second sidewalls 14, 16 at a top end. The base 10 and cover 12 may be secured to the sidewalls 14, 16 by screws 36. The present invention may further include a support block 18 and a support dowel 20 secured to the sidewalls 14, 16 behind the blocks 24 to add additional support.

In certain embodiments, the present invention may resemble a police car. For example, a plurality of large blocks 28 and a small block 30 may be secured to the cover 12. The large blocks 28 and small block 30 may include a blue and red color and may be arranged to look like police car lights. Further, different decorative blocks, such as triangular blocks 32 and arched rooftop blocks 34 may be secured to the cover 12. In certain embodiments, wheel blocks 26 having a black color may be secured to the base 10.

The rotatable blocks 24 of the present invention may be a prism shape and thereby may include three sides. Each of the three sides may include an image 38 of a portion of the same police investigative scene depiction. In certain embodiments, each of the three sides may include a different depicted item within the police investigative scene depiction. For example, a first side may include a gun, a second side may include a body, and a third side may include blood. Therefore, a user may rotate each block 24 to show the same police investigative scene depiction with a different orientation of items.

The images 38 of the present invention may include pictures or drawings that make up the full police investigative scene depiction. The images 38 may be directly etched or printed onto each side of the rotatable blocks 24. However, in certain embodiments, each of the images 38 may be secured to the side of the block by an adhesive 40.

As illustrated in FIG. 8, the present invention may be in the form of a puzzle 42. In such embodiments, the present invention may include a plurality of puzzle blocks 44. Each of the puzzle blocks 44 may include two or more sides. Each of the sides may include an image. A plurality of aligned images may also form the full police investigative scene depiction. However, each side of the puzzle blocks 44 may include a different depicted item. Therefore, a user may flip the puzzle blocks 44 to show the same scene with different items.

It should be understood, of course, that the foregoing relates to exemplary embodiments of the invention and that modifications may be made without departing from the spirit and scope of the invention as set forth in the following claims.

What is claimed is:

1. A police scene training apparatus comprising:
a first sidewall and a second sidewall;
a plurality of dowels, each comprising a first end secured to the first sidewall and a second end secured to the second sidewall, wherein the plurality of dowels are oriented above and below one another;
a plurality of blocks rotatably disposed about each of the plurality of dowels, wherein each of the plurality of blocks comprises a plurality of sides, wherein
at least two of the plurality of sides of each of the plurality of blocks comprises an image, and
a plurality of aligned sides form a surface comprising a plurality of images forming a police investigative scene depiction.

2. The police scene training apparatus of claim 1, wherein the police investigative scene depiction comprises a plurality of depicted items.

3. The police scene training apparatus of claim 2, wherein the image of a first side of a block comprises a first depicted item and the image of a second side of the block comprises a second depicted item.

4. The police scene training apparatus of claim 1, further comprising a base connecting the first and second sidewalls at a bottom end, and a cover connecting the first and second sidewalls at a top end.

5. The police scene training apparatus of claim 4, further comprising a plurality of blocks secured to the cover, wherein the blocks depict police lights.

6. The police scene training apparatus of claim 4, further comprising a plurality of blocks secured to the base, wherein the blocks depict car tires.

7. The police scene training apparatus of claim 1, wherein the plurality of blocks each comprise a prism shape having three sides.

8. The police scene training apparatus of claim 7, wherein each of the three sides of the plurality of blocks comprise a portion of the same police investigative scene depiction.

9. The police scene training apparatus of claim 8, wherein at least one of the three sides of a portion of the plurality of blocks comprises a depicted item within the police investigative scene depiction.
